(19) United States
(12) Patent Application Publication
(10) Pub. No.: US 2006/0083244 A1
(43) Pub. Date: Apr. 20, 2006

(54) Method for sessions including multiple resources

(76) Inventors: Balakumar Jagadesan, Glendale Heights, IL (US); Sanjay Gupta, Lakewood, IL (US); Lawrence A. Willis, McHenry, IL (US)

Correspondence Address: MOTOROLA INC, 600 NORTH US HIGHWAY 45, ROOM AS437, LIBERTYVILLE, IL, 60048-5343, US

(21) Appl. No.: 10/966,807

(22) Filed: Oct. 15, 2004

(51) Int. Cl. H04L 12/56

(52) U.S. Cl. 370/395.2; 370/473

(57) ABSTRACT

A method of setup and management of multiple resources in multiparty multimedia conference sessions. The method can include accepting a multiple resource session initiation request from a client, the multiple resource session initiation request requesting initiation of the multiple resource session, the multiple resource session including multiple resources. The multiple resource session initiation request can include a list of session participants and a session resource description including a plurality of group resource descriptions. Each group resource description can describe a logical group of at least one resource of at least one media type. The method can also include assigning a group identifier to each group resource description and assigning a session identifier to the session. The method can further include transmitting to the session participants the session identifier and a new session resource description. The new session resource description can include each of the group identifiers and each group resource description corresponding to each group identifier.

### BACKGROUND

1. Field

The present disclosure is directed to a method for sessions including multiple resources. More particularly, the present disclosure is directed to a method of setup and management of multiple resources in multiparty multimedia conference sessions.

2. Description of Related Art

Presently, floor control is a control mechanism that arbitrates requests from devices for the right to speak. For example, in a Push-to-Talk session, only one device at a time participating in the session is allowed to speak. A similar session service being developed is a Push-to-X service. In this service different types of media can be used to allow a group of people to share an experience with one another in real-time in a session. Such types of media can include voice, video, images, formatted data streams, or any other useful media. As an example, Push-to-Video (PTV), a type of Push-to-X application, can allow a group of people to talk to each other and also exchange a video simultaneously. In the PTV session, only one participant in the session may talk at a given time while others listen. Similarly, only one participant is allowed to push a video, while the other participants see the video on their devices.

Unfortunately, current considerations for Push-to-X do not provide for proper setup and management of multiple resources in a multiparty multimedia conference session. For example, current considerations do not provide floor control for different floors including different groups of resources. Current considerations also do not provide for dynamically changing resource groups. Current considerations additionally lack the flexibility to establish hybrid-configurations in which grouping and un-grouping of related resources is based on the use-case needs. Current considerations also restrict a device to a specific media, for example, such as still images, even if a display in an end user device has the capability to display both video and still images. Current considerations are also not adaptable to scenarios when external devices are dynamically added to a participant's device using a connectivity mechanism such as a USB connection, a Blue-tooth connection, a serial port connection, or any other connectivity mechanism. Thus, there are no floor control schemes that adequately address the multimedia needs of a Push-to-X session. These and other problems can be solved by the current disclosure.

### SUMMARY

A method of setup and management of multiple resources in multiparty multimedia conference sessions. The method can include accepting a multiple resource session initiation request from a client, the multiple resource session initiation request requesting initiation of the multiple resource session, the multiple resource session including multiple resources. The multiple resource session initiation request can include a list of session participants and a session resource description including a plurality of group resource descriptions. Each group resource description can describe a logical group of at least one resource of at least one media type. The method can also include assigning a group identifier to each group resource description and assigning a session identifier to the session. The method can further include transmitting to the session participants the session identifier and a new session resource description. The new session resource description can include each of the group identifiers and each group resource description corresponding to each group identifier.

### BRIEF DESCRIPTION OF THE DRAWINGS

The embodiments of the present disclosure will be described with reference to the following figures, wherein like numerals designate like elements, and wherein:

FIG. 1 is an exemplary block diagram of a system according to one embodiment;

FIG. 2 is an exemplary flowchart illustrating the operation of the server according to one embodiment;

FIG. 3 is an exemplary flowchart illustrating the operation of a session initiating client according to one embodiment;

FIG. 4 is an exemplary flowchart illustrating the operation of a session participant according to one embodiment;

FIG. 5 is an exemplary flowchart illustrating the operation of the system according to another more detailed embodiment;

FIG. 6 is an exemplary flowchart illustrating the operation of the system according to another more detailed embodiment;

FIG. 7 is an exemplary flowchart illustrating the operation of the system according to another more detailed embodiment; and

FIG. 8 is an exemplary flowchart illustrating the operation of a participant in a session in the system according to another more detailed embodiment.

### DETAILED DESCRIPTION

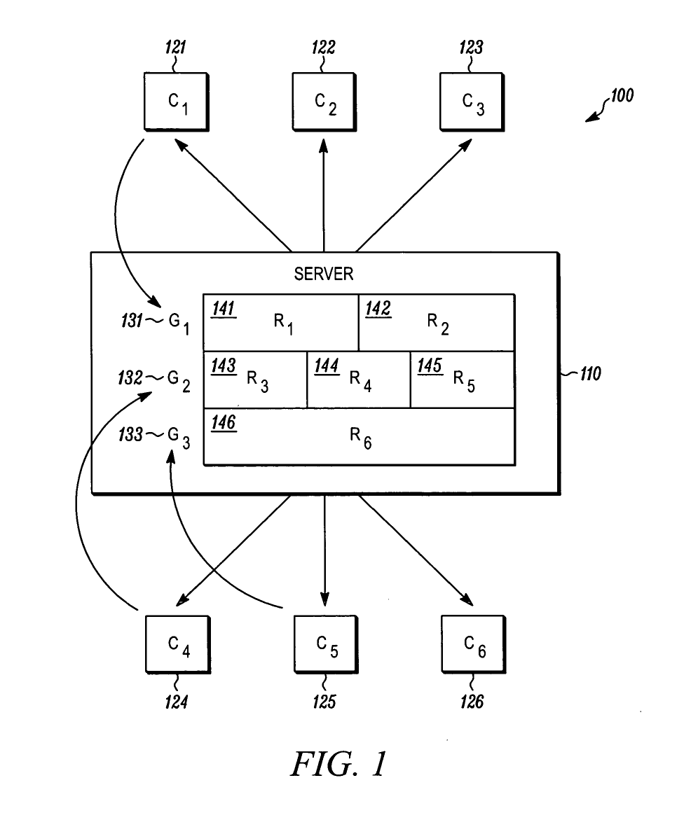

FIG. 1 is an exemplary block diagram of a system 100 according to one embodiment. The system 100 can include a server 110 and clients 121-126. The server 110 can maintain and dynamically allocate resources 141-146 to the clients 121-126 by grouping the resources into groups 131-133. For example, group 131 can include resources 141 and 142, group 132 can include resources 143-145, and group 133 can include resource 146. The groups of resources may be dynamically reconfigured by the server 110. The clients 121-126 may include telephones, wireless telephones, selective call receivers, cellular telephones, PDAs, pagers, personal computers, mobile communication devices, set top boxes, or any other device that is capable of sending and receiving communication signals on a network. The server 110 can send and receive signals to and from the clients 121-126 over a network such as a wireless network, a wired network, a wide area network, a local area network, the Internet, a cellular network, or any other network that is capable of sending and receiving communication signals.

In operation, a client 121 can request a multiparty multimedia conference session from the server 110. For example, the client 121 can send a session initiation request to the server 110. During the session initiation, a group of participants 122-126 can be invited. The resources 141-146 and the sum of the resources can be determined to know which resources 141-146 and how many of those resources are available. Decisions can be made on how those resources should be grouped into groups 131-133. The groups 131-133 can define subsets of the resources that can be transferred to a participant during the session. During the session, media and control signals can be received from selected participants 121-126 to whom groups are assigned by floor control and the media and control signals can be broadcast to all of the participants 121-126 or some of the participants based on resource availability.

During the session, the server 110 can arbitrate the groups 131-133 and resources 141-146. This can be based on actual use of the resources 141-146 and/or the sum total of the resources. For example, if multiple resources of the same type are used, the total number can be used to determine if any are available for a selected requesting participant. The server 110 can arbitrate to make sure the overall resource budget is not exceeded and to guarantee the groupings are maintained on a group floor transition. Real time control protocol, session initiation protocol, or other protocols may be used for signaling in the system 100. This protocol can be used to identify both the session and the group a requesting participant is interested in.

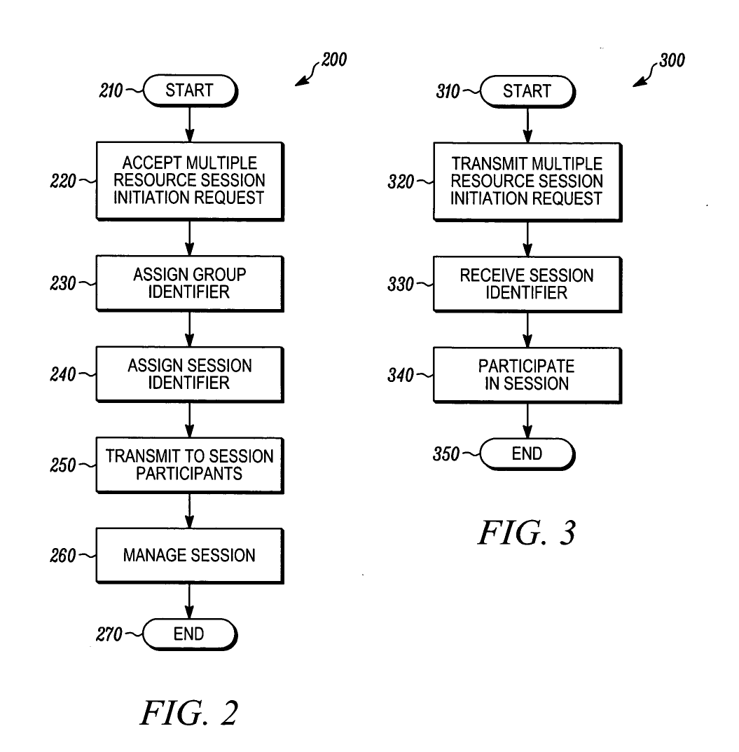

FIG. 2 is an exemplary flowchart 200 illustrating the operation of the server 110 according to one embodiment. In step 210, the flowchart begins. In step 220, the server 110 can accept a multiple resource session initiation request from a client, such as client 121. The multiple resource session initiation request can request initiation of the multiple resource session, the multiple resource session can include multiple desired resources, such as resources 141-146. The multiple resource session initiation request can contain a list of session participants, such as clients 121-126, and a session resource description. The session resource description can include a plurality of group resource descriptions, each group resource description describing a logical group, such as group 131, of at least one resource, such as resource 141. The session initiation request can include a session description. The multiple resources can be both logical resources and physical resources. For example, physical resources can include a speaker, a microphone, a display, a pointing device, a keyboard, and a keypad, or any other physical resource. Logical resources can include an application, a window, a background, a media type, an access to a service, or any other logical resource. Resources can either be integrated with the a client device, such as client software or remotely managed by the device, such as a speaker connected using Bluetooth. One media can use multiple resources, for example, an integrated audio/video stream may use a display and a speaker. Also, the same media stream may need a different set of resources at different end points depending on device and user preferences.

In step 230, the server 110 can assign a group identifier to each group resource description. In this step, the server 110 may also determine the total number of logical groups 131-133 available and maintain the total number of logical groups available. In step 240, the server 110 can assign a session identifier to the session. In step 250, the server 110 can transmit, to the session participants 121-126, the session identifier and a new session resource description. The new session resource description can include each of the group identifiers and each group resource description corresponding to each group identifier. The new session resource description may be the same as the original session description or may be different from the original session description.

In step 260, the server 110 can manage the session. For example, the server 110 can receive an acceptance from at least one session participant, such as client 122, the acceptance indicating the session participant's desire to participate in the session. The server 110 can transmit an acknowledgement of session initiation to the initiating client 121, the acknowledgement including the session identifier and the group identifiers. By transmitting the acknowledgement, the server 110 can initiate the session. While the session is in progress, the server 110 can determine a change in the total number of logical groups available and maintain a new number of logical groups, the new number of logical groups based on the change in the total number of logical groups available.

The server 110 can also manage the session when one of the participants 121-126 wants to control at least one of the resource groups 131-133. For example, the server 110 can receive a request from a requesting participant 124 containing a session identifier and a group identifier of, for example, group 132. The server 110 can determine whether the logical group 132 identified by the group identifier is available. The server 110 can accept the request and assign the logical group 132 identified by the group identifier to the requesting participant 124 if the logical group 132 identified by the group identifier is available. The server 110 can reject the request if the logical group 132 identified by the group identifier is not available.

While managing the session, the server 110 can receive media from a participant, such as client 124 to which a logical group 132 has been assigned, the logical group corresponding to the media, and can forward the media to all participants 121-126. The server 110 can also receive a request to assign at least one resource 146 to a subset 124-126 of the session participants. The request can include a group identifier associated with the at least one resource 146. The server 110 can then assign the at least one resource 146 to the subset 124-126 of the session participants.

While managing the session, the server 110 can additionally maintain information regarding resources available to a selected participant, receive an update of the resources available to the selected participant, and update the information regarding resources available to the selected participant. For example, in the initial session description, there can be a provision to indicate dynamic modification, such as the addition or removal of devices, to an existing group of devices. When a participant 126 migrates from a house to a car, the participant 126 may not have access to the same device set in the car as in the house. The participant 126 can then re-negotiate the device set with other participants. Also, if during the session, if one of the devices associated with a participant 126 malfunctions, it can be removed. Accordingly, the groups 131-133 and resources 141-146 in the groups can be expanded or reduced based on parameters or provisions provided or created during the initial establishment of session rules.

While managing the session, the server 110 can further maintain information regarding at least one resource 146, receive a request to split the at least one resource 146 into at least two resources, and assign each of the at least two resources a group identifier. The at least two resources may be assigned the same group identifier, may be assigned different group identifiers, may be assigned a new group identifier, may be assigned and existing group identifier, or may be combined with other existing resources into an existing group. Thus, the server 110 can functionally split an existing device into two sub-devices. These sub-devices could then be re-negotiated during the session for agreement. For example, if group 133 has an entire terminal display functionally the terminal display can be split into a foreground display and a background display. During re-negotiation, a session level agreement can be obtained based on resource updates. A client could then share the sub-devices to other floors. Analogously, while managing the session, the server can additionally maintain information regarding at least two resources 141 and 142, receive a request to combine the at least two resources 141 and 142 into at least one resource, and assign the at least one resource a group identifier. Rules may also be utilized for moving a resource from one group to another group. For example, during the initial negotiation, group 132 may have three resources 143-145, such as speakers. If all three speakers are not used in the group, one or more speakers may be moved from group 132 to group 133. In step 260, the flowchart 200 can end.

FIG. 3 is an exemplary flowchart 300 illustrating the operation of a session initiating client, such as client 121, according to one embodiment. In step 310, the flowchart 300 begins. In step 320, the client 121 can transmit a multiple resource session initiation request. The multiple resource session initiation request can request initiation of a multiple resource session. The multiple resource session initiation request can contain a list of session participants and a session resource description. The session resource description can include a plurality of group resource descriptions. Each group resource description can describe a logical group of at least one resource of at least one media type. The multiple resource initiation request can be transmitted to the server 110. In step 330, the client 121 can receive a session identifier assigned to the session and a new session resource description. The new session resource description can include group identifiers assigned to each group resource description. The new session resource description can also include each group resource description corresponding to each group identifier. In step 340, the client 121 can participate in the session. While participating in the session, the client 121 can transmit a resource request containing a session identifier and a group identifier and receive a request acceptance. The request acceptance can assign the logical group identified by the group identifier to the client 121. In step 350, the flowchart 300 can end.

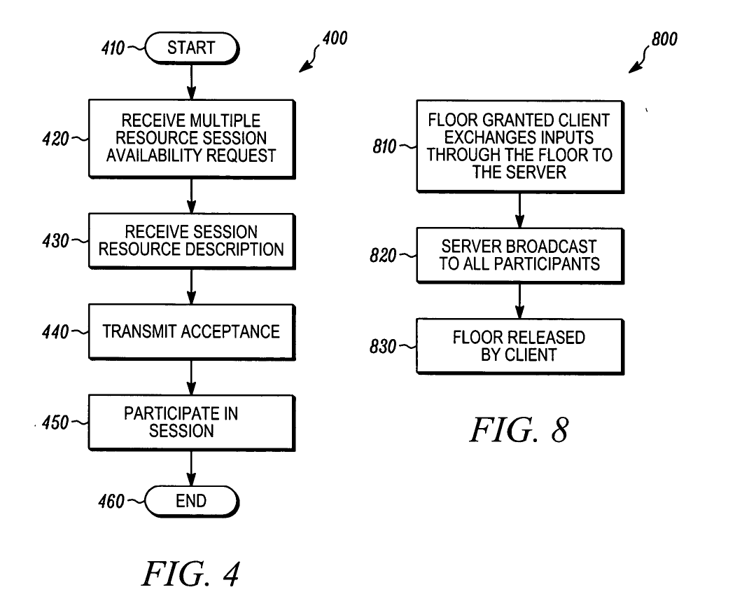

FIG. 4 is an exemplary flowchart 400 illustrating the operation of a session participant, such as client 121 or client 122, according to one embodiment. In step 410, the flowchart begins. In step 420, the client 122 can receive an availability request for a multiple resource session, for example, from the server 110. The availability request can include a session identifier. In step 430, the client 122 can receive a session resource description including a plurality of group identifiers and associated group resource descriptions. Each group resource description can describe a logical group, such as group 131, of at least one resource, such as resources 141 and 142. In step 440, the client 122 can transmit an acceptance of the multiple resource session, for example, to the server 110. In step 450, the client 122 can participate in the session. For example, the client 122 can transmit a resource request containing a session identifier and a group identifier. If the resource is available, the client 122 may then receive a request acceptance assigning the logical group identified by the group identifier to the client's electronic device. In step 460, the flowchart can end.

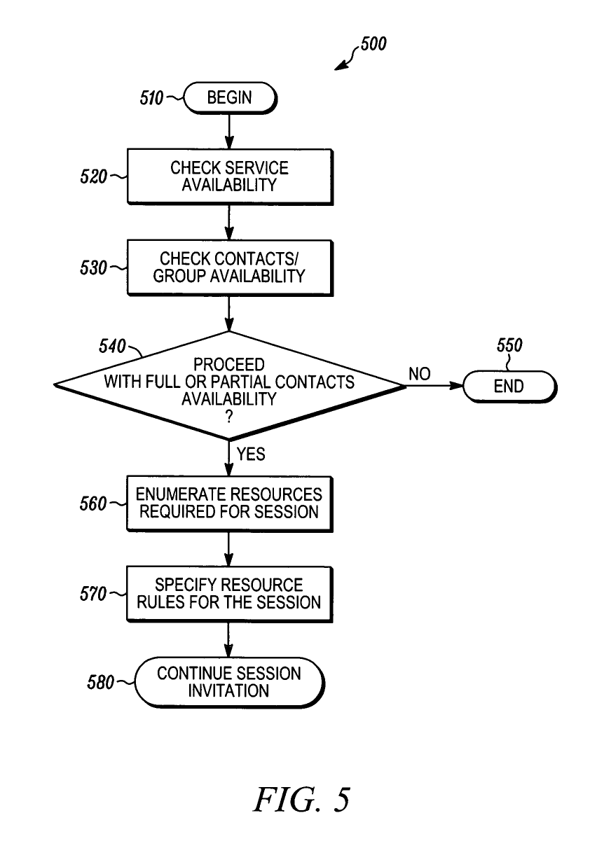

FIG. 5 is an exemplary flowchart 500 illustrating the operation of the system 100 according to another more detailed embodiment. Flowchart 500 can illustrate a session registration process of the system 100. In step 510, the flowchart 500 begins. In step 520, a client 121 can check for service availability from the server 110. For example, the server 110 can inform the client 121 of available services for multiparty multimedia conference sessions. In step 530, the client 121 can check for potential participant availability. For example, the client 121 can check a buddy list, a contact list, and/or a group list for desired participants. The client 121 can send an availability request and receive a response regarding the available participants from the server 110. In step 540, the client 121 can determine whether to proceed with the full amount or a partial amount of available participants. If there are no available participants or if the client 121 decides it does not want to continue with only a partial amount of available participants, in step 550, the client 121 can discontinue setting up the session. If all of the participants are available or the client 121 decides to continue with a partial number of participants, the flowchart advances to step 560. In step 560, the client 121 and/or the server 110 can enumerate the resources required and/or desired for the session. In step 570, the client 121 and/or the server 110 can specify resource rules for the session. For example, resources may be grouped into groups 131-133. Also, a session moderator can be designated, participant's permissions can be set, and access rules, function rules, and the like can be set for session participants and the session moderator. In step 580, the flowchart advances to session invitation of the participants.

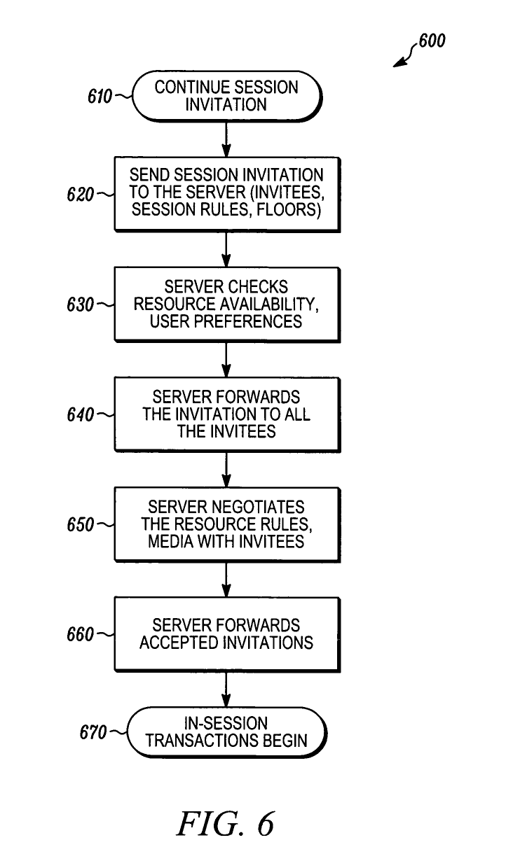

FIG. 6 is an exemplary flowchart 600 illustrating the operation of the system 100 according to another more detailed embodiment. Flowchart 600 can illustrate a session setup process including session invitation. In step 610, the flowchart 600 begins. In step 620, the client 121 can send a session invitation to the server. The session invitation may be a session initiation request including the invited participants, the session rules, the floors/groups, and any other useful information for a session invitation. In step 630, the server 110 can check resource availability and preferences of the potential participants, such as clients 122-126. In step 640, the server 110 can forward the invitation to all of the invited participants. In step 650, the server 110 can negotiate the resource rules and the media with the invited participants. For example, the server 110 can determine if possible alternatives are available if certain resources are not available or are limited at a invited participant. In step 660, the server 110 can forward the accepted invitations to the originating client 121. In step 670, the flowchart 600 advances to the in-session transaction process.

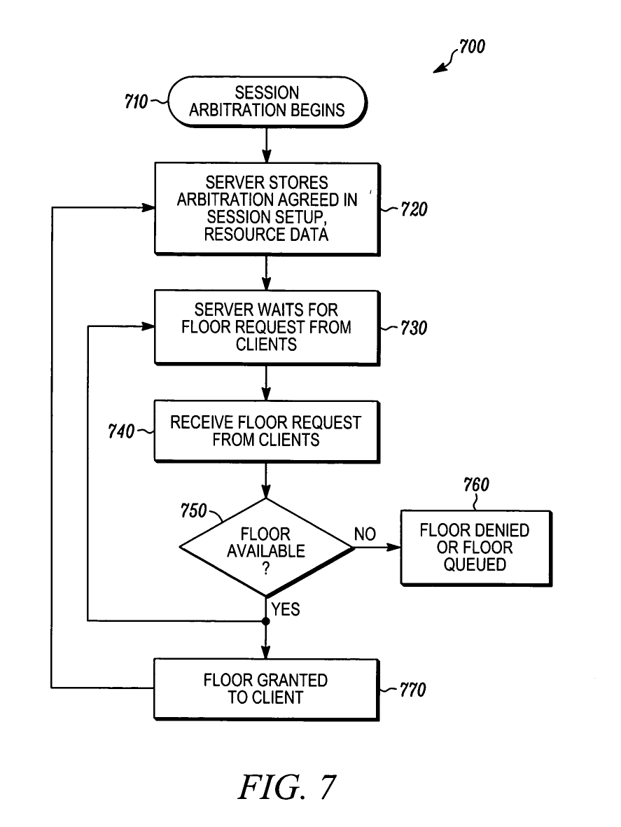

FIG. 7 is an exemplary flowchart 700 illustrating the operation of the system 100 according to another more detailed embodiment. Flowchart 700 can illustrate an in-session transaction process such as session arbitration in the system 100. In step 710, the flowchart 700 begins. In step 720, the server 110 stores the session rules, parameters, and resource data agreed upon in session setup. In step 730, while sending and receiving media and control operations, the server 110 can wait for floor/group requests from the participants 121-126. In step 740, the server 110 can receive a floor/group request from a participant. In step 750, the server 110 can determine if the request satisfies the group availability rules. For example, the server 110 can determine if the group is available. If the group is not available, in step 760, the server 110 either denies or queues the request. If the group is available, in step 770 the server 110 grants the floor/group to the requesting participant. The server 110 can also continue to monitor for other floor/group during this process. The server 110 can then update the group and resource data in step 720 and continue the process until the session ends.

FIG. 8 is an exemplary flowchart 800 illustrating the operation of a participant in a session in the system 100 according to another more detailed embodiment. The flowchart 800 can illustrate the operation of a participant that receives the grant of a group from the server 110. In step 810, a floor/group can be granted to a client and inputs can be exchanged through the floor/group to the server 110. For example, the client 124 can receive a grant of the group 122 from the server 110. In step 820, the server 110 can broadcast the information received from the client 124 to all participants 121-126. For example, the server can broadcast media received from the client 124 to the participants 121-126. This can be done until the floor/group is released by the client 124 in step 830. The group may also be forcibly released by the server 110 based on a time out, by a group moderator, such as the session initiating client 121, or for any other useful reason.

Thus, the present disclosure can provide for a method for a Push-to-X (PTX) application that can be based on resources that are required at an end user device. For example, independent floor/group control entities can be used for one or more resources such as a microphone and speaker pair, a display assigned to an application, windows on the display treated as individual resources, device vibration, device lights, wallpaper on a display, memory on a device, processor functions on a device, and other entities. Participants in the PTX session can request one or more resources and then use the resources in a desired way. A resource, such as wallpaper for a whole display screen or a part thereof can have a floor control group identifier associated with it. This can then be used to create collaboration applications. The participant in control of the wallpaper resource can then assign an image to be the wallpaper and relinquish control of the display to other participants. For example, a picture of a job-site can be used as the wallpaper on top of which an expert participant can annotate instructions to help explain how a task must be accomplished.

The present disclosure can also provide for a participant to have an opportunity to control an entire application for collaborative applications by defining the entire application as an arbitration item. If the application controls multiple resources then all the resources can get tied to the same participant. For example, all of the resources of a whiteboard application can be used by the same participant. The present disclosure further provides for a user interface that is intuitive to a participant's needs. The participant can easily request, release, add and remove an array of resources. Thus, the present disclosure can provide for a scalable floor control scheme that adapts to the various use-cases involving multiple media streams in a PTX application.

The present disclosure can also allow for a participant device to function as a floor control manager for routing media streams for its own resources, external resources with independent Internet Protocol (IP) end points, external devices without IP endpoints, or other resources. The present disclosure further provides for setting up a session based on device negotiation, for example, using Session Initiation Protocol (SIP) and/or Session Description Protocol. For example, a floor control parameter can be sent by the conference server 110 in response to the SIP Invite message from an originating client. A group of resources can be tied to a given group, such as a floor, using a “μL” parameter in the SIP message. A group identifier can be used for a given floor in such a multiparty multimedia conference session. The group identifier is then assigned to a set of resources involved in the floor. All of the resources, such as wallpaper, processor, display windows, speaker, touchpad, and the like, in a given session can be uniquely identified through the attribute parameters. The resources can be configured as different floors, based on the PTX use-case scenarios. There can be capability to update the session based on the device availability. The group identifier can be the link between grouped resources. If devices are dynamically added to the participant's device, then the underlying resource group and media negotiation can be updated. Also, the floor control traffic can be separated from the media traffic. In another embodiment, the device can act as a virtual floor control manager for other IP end points which can use for media handling. All the floor control messages can be routed to the same IP address. So all the floors involved in a PTX session can be grouped to a floor control device. Additionally, each floor can have the capability to use its own floor control protocol for carrying floor control traffic. Furthermore, a naming scheme, for example, similar to universal plug-and-play device architecture name space, can be provided as an option. Thus, the present disclosure can enable device based negotiation, which can involve lesser data and can be more effective form of negotiation in closed system, such as a mobile communication system. This device based negotiation can belong to the same operator and the operator can control the devices and types of accessories.

The present disclosure can be used in any type of collaborative, multi-media or resource sharing applications in half-duplex or full-duplex scenarios residing in any system, either mobile or fixed.

The method of this disclosure is preferably implemented on a programmed processor. However, the processes may also be implemented on a general purpose or special purpose computer, a programmed microprocessor or microcontroller and peripheral integrated circuit elements, an ASIC or other integrated circuit, a hardware electronic or logic circuit such as a discrete element circuit, a programmable logic device such as a PLD, PLA, FPGA or PAL, or the like. In general, any device on which resides a finite state machine capable of implementing the flowcharts shown in the Figures may be used to implement the processes and methods of this disclosure.

While this disclosure has been described with specific embodiments thereof, it is evident that many alternatives, modifications, and variations will be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the disclosure by simply employing the elements of the independent claims. Accordingly, the preferred embodiments of the disclosure as set forth herein are intended to be illustrative, not limiting. Various changes may be made without departing from the spirit and scope of the disclosure.

What is claimed is:

1. A method in a server, the method comprising:
accepting a multiple resource session initiation request from a client, the multiple resource session initiation request requesting initiation of the multiple resource session, the multiple resource session including multiple desired resources, the multiple resource session initiation request containing:
a list of session participants, and
a session resource description including a plurality of group resource descriptions, each group resource description describing a logical group of at least one resource;
assigning a group identifier to each group resource description;
assigning a session identifier to the session; and
transmitting to the session participants the session identifier and a new session resource description, the new session resource description including each of the group identifiers and each group resource description corresponding to each group identifier.

2. The method according to claim 1, further comprising:
receiving an acceptance from at least one session participant.

3. The method according to claim 1, further comprising:
transmitting an acknowledgement of session initiation to the client, the acknowledgement including the session identifier and the group identifiers.

4. The method according to claim 3, wherein transmitting the acknowledgement comprises initiating the session by transmitting an acknowledgement of session initiation to the client.

5. The method according to claim 1, further comprising:
determining the total number of logical groups available; and
maintaining the total number of logical groups available.

6. The method according to claim 5, further comprising:
determining a change in the total number of logical groups available; and
maintaining a new number of logical groups, the new number of logical groups based on the change in the total number of logical groups available.

7. The method according to claim 1, further comprising:
receiving a request from a requesting participant containing a session identifier and a group identifier;
determining whether the logical group identified by the group identifier is available;
accepting the request and assigning the logical group identified by the group identifier to the requesting participant if the logical group identified by the group identifier is available; and
rejecting the request if the logical group identified by the group identifier is not available.

8. The method according to claim 1, further comprising:
receiving media from a participant to which a logical group has been assigned, the logical group corresponding to the media; and
forwarding the media to all participants.

9. The method according to claim 1, wherein the session initiation request further includes a session description.

10. The method according to claim 1, wherein the multiple resources comprise both logical resources and physical resources.

11. The method according to claim 10, wherein physical resources include at least one of a speaker, a microphone, a display, a pointing device, a keyboard, and a keypad, and
wherein logical resources include at least one of an application, a window, a background, a media type, and an access to a service.

12. The method according to claim 1, further comprising:
receiving a request to assign at least one resource to a subset of the session participants, the request including a group identifier associated with the at least one resource; and
assigning the at least one resource to the subset of the session participants.

13. The method according to claim 1, further comprising:
maintaining information regarding resources available to a selected participant;
receiving an update of the resources available to the selected participant; and
updating the information regarding resources available to the selected participant.

14. The method according to claim 1, further comprising:
maintaining information regarding at least one resource;
receiving a request to split the at least one resource into at least two resources; and
assigning each of the at least two resources a group identifier.

15. The method according to claim 1, further comprising:
maintaining information regarding at least two resources;
receiving a request to combine the at least two resources into at least one resource; and
assigning the at least one resource a group identifier.

16. A method in an electronic device, the method comprising:
transmitting a multiple resource session initiation request, the multiple resource session initiation request requesting initiation of the multiple resource session, the multiple resource session initiation request containing:
a list of session participants, and
a session resource description including a plurality of group resource descriptions, each group resource description describing a logical group of at least one resource;
receiving a session identifier assigned to the session and a new session resource description, the new session resource description including group identifiers assigned to each group resource description, the new session resource description also including each group resource description corresponding to each group identifier.

17. The method according to claim 16, wherein the multiple resources comprise both logical resources and physical resources.

18. The method according to claim 16, further comprising:
transmitting a resource request containing a session identifier and a group identifier; and
receiving a request acceptance assigning the logical group identified by the group identifier to the electronic device.

19. The method according to claim 16, wherein the electronic device comprises a mobile communication device.

20. A method in an electronic device, the method comprising:
receiving an availability request for a multiple resource session the availability request including a session identifier;
receiving a session resource description including a plurality of group identifiers and associated group resource descriptions, each group resource description describing a logical group of at least one resource; and
transmitting an acceptance of the multiple resource session.

21. The method according to claim 20, further comprising
transmitting a resource request containing a session identifier and a group identifier; and
receiving a request acceptance assigning the logical group identified by the group identifier to the electronic device.

22. The method according to claim 20, wherein the electronic device comprises a mobile communication device.
